(19) United States
(12) Patent Application Publication
(10) Pub. No.: US 2006/0104015 A1
(43) Pub. Date: May 18, 2006

(54) NOTEBOOK COMPUTER WITH A ROTATABLE LENS MODULE

(76) Inventors: Chih-Yin Fu, Hsinchu City (TW); Chen-Cheng Wang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,690

(22) Filed: Sep. 20, 2005

(30) Foreign Application Priority Data
Nov. 18, 2004 (TW) 93135497

(51) Int. Cl. G02F 1/1335

(52) U.S. Cl. 361/681

(57) ABSTRACT

A notebook computer with a rotatable lens module is provided. The notebook has a liquid crystal display (LCD) panel, in addition to the lens module. The lens module includes a housing rotatably fixed to the LCD panel. A lens is installed in the housing for capturing image. A rotating member is rotatably fixing the housing to the LCD panel. The rotating member is capable of rotating the housing from a first angle smaller than zero degree to a second angle larger than 180 degrees.

### CROSS-REFERENCE TO RELATED APPLICATION

This application claims the priority benefit of Taiwan application serial no. 93135497, filed on Nov. 18, 2004. All disclosure of the Taiwan application is incorporated herein by reference.

### BACKGROUND OF THE INVENTION

1. Field of Invention

The present invention relates to a notebook computer and more particularly to a notebook computer with a rotatable lens module.

2. Description of Related Art

Recently, the selling price of notebook computers is no longer too high to buy because of the substantially price reduction of LCD (liquid crystal display) panel. Therefore, general users are favoring notebook computers. In addition, notebook computer with lens and wireless network interface card can transmit the captured image to friends at a remote site by Internet anytime and anywhere.

Referring to FIG. 1, it is a diagram schematically showing a conventional notebook computer 10 with a lens 12. Notebook computer 10 further includes an LCD panel 14 and a host 16. Lens 12 is disposed on top of the LCD panel 14 to capture an image in front of the LCD panel 14.

Since the lens 12 constantly faces to a front of LCD panel 14, the notebook computer 10 can only capture the image in front of the LCD panel 14 and incapably capture the image at upper or rear side of the LCD panel 14.

Referring to FIG. 2 and FIG. 3, they are a perspective diagram and a cross-sectional diagram of the conventional notebook computer 50 with a rotatable lens module 52. The rotatable lens module 52 is disposed on top of the LCD panel 14, and is capable of rotation so as to capture images at front, upper and rear sides of the LCD panel 14.

The rotatable lens module 52 includes a housing 56, a lens 12 disposed on the housing 56, and a rotatable member 54 fixed to the LCD panel 14. The rotatable member 54 can rotate the lens 12 from 0 degree to 180 degrees so that the lens 12 can capture images around notebook computer 50. For example, the lens 12 of the notebook computer can capture front-side images of LCD panel 14 while no rotation, the lens 12 can capture the upper image of the notebook computer 50 while rotating by 90 degrees that is vertical to the LCD panel 14, and the lens 12 can capture the rear-side image of the LCD panel 14 while rotating 180 degrees that is parallel to the LCD panel 14.

As described above, in accordance with development of the Internet, a user of notebook computer 50 can transmit not only the text data but also the image data (particularly to the user's own image, instantly captured by the lens 12) to friends at the remote site by network transmission. In this manner, the friends of the user at the remote site can also view the user's own image in time while accessing the text data transmitted by the user via the computer system, which is connected with the notebook computer 50 of the user in Internet.

Generally, as shown in FIG. 3, when a user uses a notebook computer 10 to view the data displayed on the LCD panel 14, the LCD panel 14 is tilted by a predetermined angle rather than being vertical to the host 16, so as to prevent the light reflection of LCD panel 14 from interfering the user. However, as described above, since the minimum rotatating angle of rotatable lens module 52 is 0 degree only, therefore, the in-time image captured by the lens 12 of the notebook computer 50 still can't see the user. In other words, the user's friend at a distant place can't see the user from his computer system.

### SUMMARY OF THE INVENTION

It's therefore an objective of the present invention to provide a notebook computer with a rotatable lens module. The rotatable lens module can rotate from −30 degree to 210 degree. Therefore, the rotatable lens module of the notebook computer can still completely capture the instant image of the user even though the LCD panel of the notebook computer must tilt by a predetermined angle to avoid light reflection.

According to an aspect of the present invention, which discloses a notebook computer with a rotatable lens module, the notebook computer further includes an LCD panel. The rotatable lens module includes a housing rotatably fixed to the LCD panel, a lens installed in the housing for capturing image, and a rotating member for rotatably fixing the housing to the LCD panel. The rotating member is capable of rotating the housing from a first angle smaller than zero degree to a second angle larger than 180 degrees.

In embodiments of the present invention, the first angle is −30 degree and the second angle is 210 degree. The rotating member includes a rotatable shaft, fixed to the LCD panel, a stop washer provided on the rotatable shaft, a first bracket fixed to the housing, a second housing capable of stopping the first bracket to the stop washer, a first washer provided on the rotatable shaft, a first spring washer provided on the rotatable shaft and located near the first washer, a nut provided on the rotatable shaft and a die-casting being cast inside the die of the nut.

The advantage of the present invention is that the lens of notebook computer can still completely capture the instant image of the user after the rotatable member rotating to −30 degrees even through the LCD panel of the notebook computer is tilted by a predetermined angle.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram, schematically showing a conventional notebook computer with a lens.

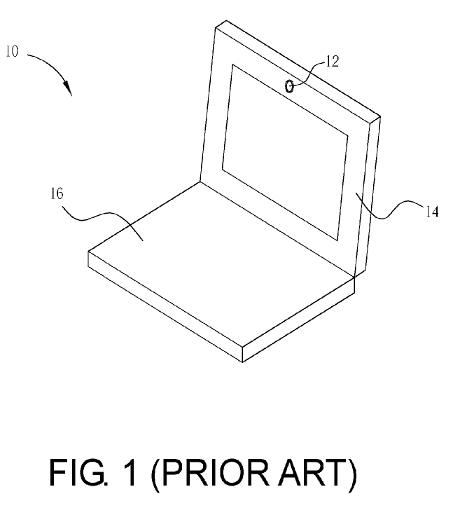

FIG. 2 is a diagram, schematically showing a conventional notebook computer with a rotatable lens module.

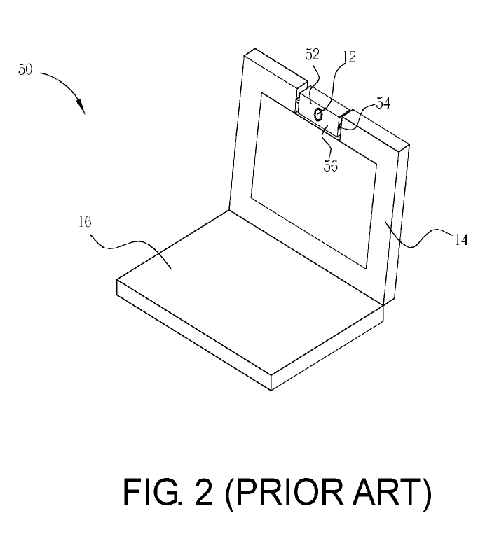

FIG. 3 is a cross sectional diagram of notebook computer of FIG. 2.

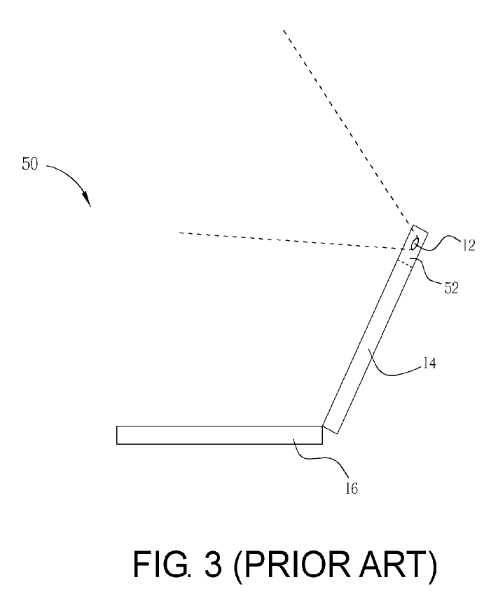

FIG. 4 is a diagram, schematically showing a notebook computer with a rotatable lens module, according to the preferred embodiment of the present invention.

FIG. 5 is a cross-sectional view, schematically showing the diagram of notebook computer of FIG. 4.

FIG. 6 is an exploded diagram, schematically showing the rotatable member with LCD panel of the notebook computer of FIG. 4.

FIG. 7 is an exploded diagram, schematically showing the rotatable member of FIG. 6.

### DESCRIPTION OF THE PREFERRED EMBODIMENTS

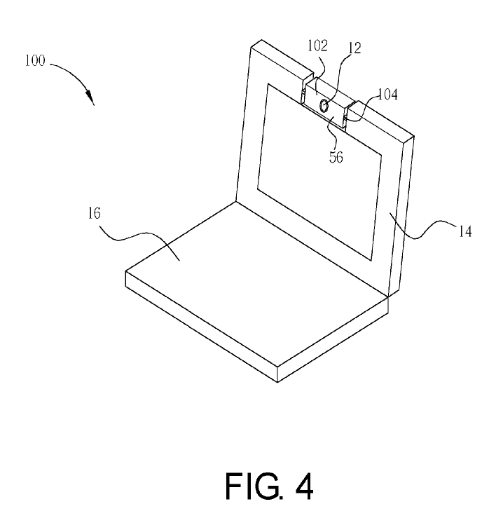

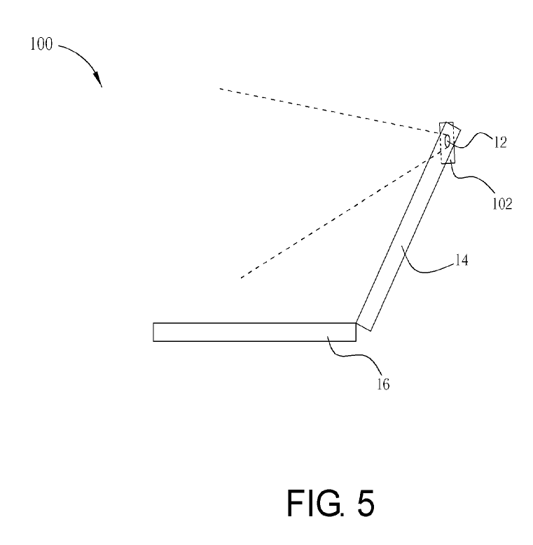

Referring to FIG. 4 and FIG. 5, which are a diagram and a cross sectional diagram of the notebook computer 100 of the preferred embodiment of the present invention. In addition to the host 16 and the LCD panel 14, the notebook computer 100 further includes a rotatable lens module 102.

The rotatable lens module 102 includes a housing 56, a lens 12 provided on the housing 56 and a rotatable member 104 fixed to the LCD panel 14. Unlike the lens 12 of the conventional rotatable member 54 in the rotatable lens module 52 of the notebook computer 50 that is capable of only rotate from 0 degree to 180 degrees, the rotatable member 104 of rotatable lens module 102 of notebook computer 100 of the present invention can rotate the lens 12 from −30 degrees to 210 degrees, the housing 54 is actually rotated by the rotatable member 104 from −30 degrees to 210 degrees). As shown in FIG. 5, the lens 12 can still capture the instant image of the user after being rotated by rotatable member 104 to −30 degrees even though the user of the notebook computer 100 doesn't sit in front of the notebook computer 100.

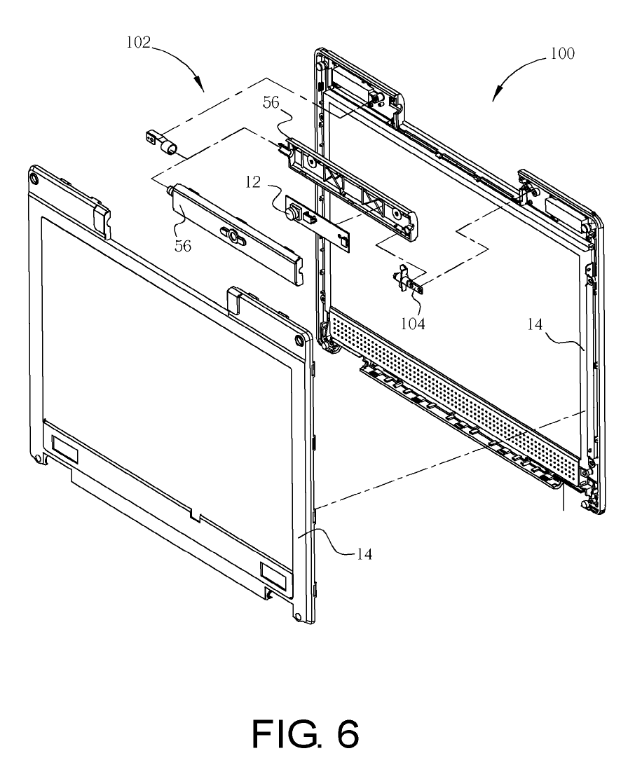

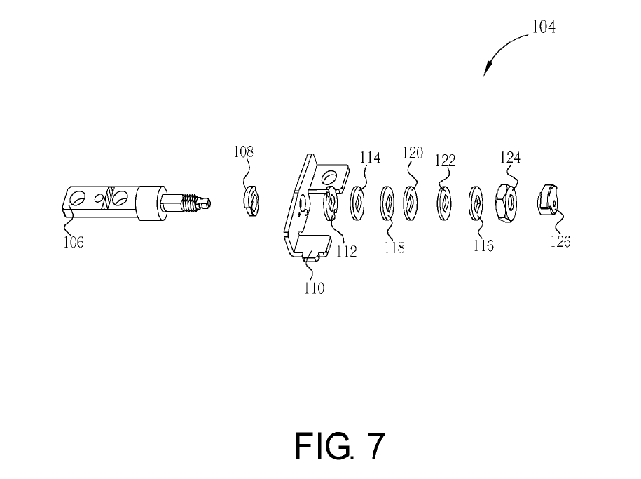

Referring to FIGS. 6 and 7, FIG. 6 is an exploded schematic diagram of a rotatable lens module 102 and the LCD panel 14 of the notebook computer 100. FIG. 7 is an exploded schematic diagram of the rotatable member 104. The rotatable member 104 includes a rotatable shaft 106 fixed to the LCD panel 14, a stop washer 108 disposed on the rotatable shaft 106, a first bracket 110 fixed to the housing 56, a second bracket 112 capable of stopping the first bracket 110 to the stop washer 108, a first washer 114 and a second washer 116 disposed on the rotatable shaft 106. A third spring washer 118, a second spring washer 120 and a first spring washer 122 are disposed on the rotatable shaft 106 and between respectively the first washer 114 and the second washer 116. A nut 124 is disposed on the rotatable shaft 106. A die-casting 126 is cast inside the die of the nut 124. The rotatable member 104 can rotate the lens 12 from −30 degrees to 210 degrees by appropriately changing the angle of the stop washer 108.

In the preferred embodiment of the present invention, the rotatable lens module 102 of the notebook computer 100 is disposed over the LCD panel 14. However, the rotatable lens module of the notebook computer of the present invention can alternatively be disposed on any one of both sides of the LCD panel 14, or even disposed at the lower side of the LCD panel. In this way, the rotatable lens module of notebook computer can capture the instant image around the user by left or right rotation.

In comparing the present invention with the prior arts, the notebook computer of the present invention includes an LCD panel, a host and a rotatable lens module. The rotatable lens module includes a lens, a housing and a rotatable member. The rotatable member includes a rotatable shaft, a stop washer, a first bracket, a second bracket, a washer, a spring washer, a nut and a die-casting. The rotatable member can rotate the lens from −30 degrees to 210 degrees by appropriately changing the angle of the stop washer. In this way, the lens of the notebook computer can still fully capture the instant image of the user after being rotated by the rotatable member to −30 degrees even if the LCD panel of the notebook computer is tilted by a predetermined angle.

What is claimed is:

1. A notebook computer, comprising:
a liquid crystal display (LCD) panel; and
a rotatable lens module, which comprises:
a housing, rotatably fixed to the LCD panel;
a lens, disposed inside the housing to capture images, and
a rotatable member, to rotatably fix the housing to the LCD panel, the rotatable member rotates the lens within a range from a first angle smaller than zero degree to a second angle larger than 180 degrees.

2. A notebook computer as claimed in claim 1, wherein the first angle is −30 degrees.

3. A notebook computer as claimed in claim 1, wherein the second angle is 210 degrees.

4. A notebook computer as claimed in claim 1, wherein the rotatable member comprises,
a rotatable shaft, fixed to the LCD panel,
a stop washer, disposed on the rotatable shaft,
a first bracket, fixed to the housing,
a second bracket, for stopping the first bracket to the stop washer,
a first washer, disposed on the rotatable shaft,
a first spring washer, disposed on the rotatable shaft and located near the first washer, and
a nut, disposed on the rotatable shaft.

5. A notebook computer as claimed in claim 4, wherein the rotatable shaft further comprises a die-casting, being cast inside the die of the nut.

6. A notebook computer as claimed in claim 4, wherein the rotatable member further includes a second washer provided on the rotatable shaft, the first spring washer is provided between the first washer and the second washer.

7. A notebook computer as claimed in claim 6, wherein the rotatable member further includes a second spring washer provided on the rotatable shaft, the second spring washer is located between the first washer and the first spring washer.

8. A notebook computer as claimed in claim 1, wherein the rotatable lens module is provided on one side of the LCD panel.

9. A rotatable lens module used in the notebook computer, the notebook computer includes a LCD panel, the rotatable lens module includes,
a housing rotatably fixed to the LCD panel,
a lens provided inside the housing to capture images, and
a rotatable member capable of rotatably fixed the housing to the LCD panel, the rotatable member is capable of rotating the lens from a first angle smaller than 0 degree to a second angle larger than 180 degree.

10. A rotatable lens module as claimed in claim 9, wherein the first angle is −30 degree.

11. A rotatable lens module as claimed in claim 9, wherein the second angle is 210 degree.

12. A rotatable lens module as claimed in claim 9, wherein the rotatable member includes,
a rotatable shaft fixed to the LCD panel,
a stop washer provided on the rotatable shaft,
a first bracket fixed on the housing,
a second bracket capable of stopping the first bracket to the stop washer,
a first washer provided on the rotatable shaft,
a first spring washer provided on the rotatable shaft and located near the first washer, a nut provided on the rotatable shaft.

13. A rotatable lens module as claimed in claim 12, wherein the rotatable member further includes a die-casting being cast inside the die of the nut.

14. A rotatable lens module as claimed in claim 12, wherein the rotatable member further comprises a second washer disposed on the rotatable shaft, and the first spring washer is located between the first washer and the second washer.

15. A rotatable lens module as claimed in claim 14, wherein the rotatable member further comprises a second spring washer disposed on the rotatable shaft, and the second spring washer is located between the first washer and the first spring washer.

16. A rotatable lens module as claimed in claim 9, wherein the housing is rotatably fixed to one side of the LCD panel.
